(19) United States
(12) Patent Application Publication
(10) Pub. No.: US 2018/0334077 A1
(43) Pub. Date: Nov. 22, 2018

(54) TIE DOWN APPARATUS, SYSTEM, METHOD

(71) Applicant: LIPPERT COMPONENTS, INC., Elkhart, IN (US)

(72) Inventors: John Suppinger, New Carlisle, IN (US); Dominick Bilancio, Elkhart, IN (US); Trenton Miller, Goshen, IN (US)

(21) Appl. No.: 15/981,278

(22) Filed: May 16, 2018

Related U.S. Application Data
(60) Provisional application No. 62/507,469, filed on May 17, 2017.

(51) Int. Cl. B60P 7/08; B21D 22/02

(52) U.S. Cl. CPC B60P 7/0815; B21D 22/02

(57) ABSTRACT

A tie down track in the form of a five-sided structure having a top defining a plurality of holes therethrough and four walls extending from and connected thereto is formed monolithically.

### CROSS-REFERENCE TO RELATED APPLICATIONS

This application claims benefit under 35 U.S.C. § 119 of U.S. Provisional Patent Application No. 62/507,469, filed on May 17, 2017, and incorporates by reference the disclosure thereof in its entirety.

### BACKGROUND AND SUMMARY OF THE DISCLOSURE

A vehicle, for example, a truck, a cargo trailer, or recreational vehicle, may be used to transport cargo, for example, a motorcycle or ATV. In order to safely transport the cargo, the cargo must be secured to the vehicle. Such securement typically is accomplished by connecting a tie down strap between the cargo and an attachment point on the vehicle, the vehicle attachment point being configured to selectively receive a hook at an end of the tie down strap. The vehicle attachment point may take the form of a D-ring extendable from a housing attached to the chassis of the vehicle, for example, to a longitudinal frame rail, a cross member, or other structural member. Alternatively, the vehicle attachment point may take the form of a tie down track attached to the vehicle as discussed above.

One such tie down track T is embodied as one or more rods R attached to a short section of a tubular structure S, for example, one or more steel rods welded to a short section of steel pipe or a short section of square or rectangular tube steel, as shown in FIGS. 1A-1D. Such a tie down track T may be attached directly to a vehicle as discussed above. Alternatively, one or more such tie down tracks could be attached to a base plate B, for example, by welding the tie down track(s) to the base plate. The base plate could be attached to the vehicle as discussed above.

In order that the uppermost surfaces of the rods of the tie down track do not extend above the uppermost edge of the tubular structure to which they are attached, U-shaped slots U about as wide and deep as the diameter of the rods R may be formed into the sidewalls of the tubular structure, the slots extending inwardly from an edge of the tubular structure. The rods may then be placed into the slots and welded to the sidewalls of the tubular structure.

A tie down track according to the present disclosure may involve fewer raw materials and be easier to manufacture than the foregoing tie down track, thereby reducing cost and complexity. Also, a tie down track according to the present disclosure may be manufactured without welding, thereby further reducing cost and complexity and eliminating a potential failure mode, namely weld failure.

### BRIEF DESCRIPTION OF THE DRAWINGS

FIG. 1-1E are various views of a known tie down track, portions thereof, and plural ones thereof attached to a base plate;

FIGS. 2A-2E are various views of a tie down track according to the present disclosure and a blank from which the tie down track may be formed;

FIG. 3A is a top plan view showing plural ones of a tie down track according to the present disclosure attached to a mounting plate;

FIG. 3B is a side elevation view of the tie down tracks and mounting plate of FIG. 3A;

FIG. 3C is a top plan view of the mounting plate of FIG. 3A in isolation; and

FIG. 4 is a perspective view of the assembly of FIG. 3A attached to a vehicle chassis.

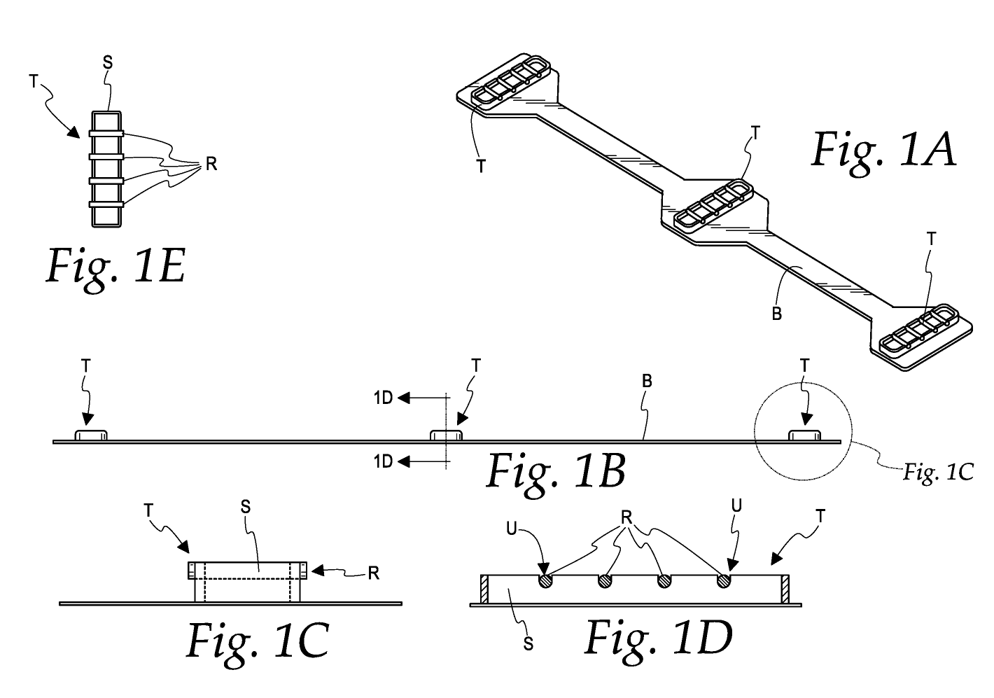

### DETAILED DESCRIPTION OF THE DRAWINGS

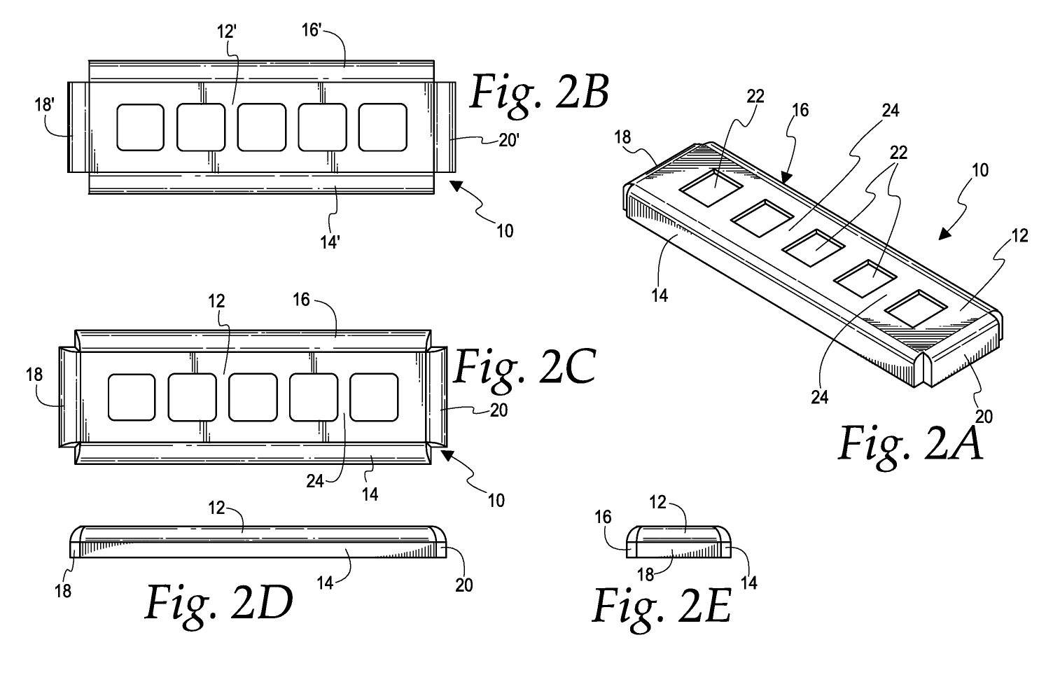

As best shown in FIGS. 2A-2E, a tie down track 10 according to the present disclosure resembles an elongated five-sided box having a top 12, a first side wall 14, a second sidewall 16, a first end wall 18, and a second end wall 20. Each of the first side wall 14, the second sidewall 16, the first end wall 18, and the second end wall 20 extends in generally the same direction from a corresponding edge of the top 12. At least a portion of any or all of first side wall 14, the second sidewall 16, the first end wall 18, and the second end wall 20 may be, but need not be, perpendicular to the top 12. Each of the first side wall 14, the second sidewall 16, the first end wall 18, and the second end wall 20 includes a free edge opposite its attachment to the top 12. Adjacent ends of any or all of the first side wall 14, the second sidewall 16, the first end wall 18, and the second end wall 20 may be, but need not be, connected together.

The top 12 defines a plurality of holes 22 therethrough. The holes 22 may be arranged in an array, which may be a linear array. Adjacent pairs of the holes 22 cooperate to define a cross bar 24 therebetween. The tie down tracktrack 10 is configured so that, with the tie down track attached to a planar backing, for example, a described further below, a hook associated with a tie down strap (not shown) may be routed through one of the holes 22 from a first side of the top 12 to a second side of the top, behind an adjacent cross bar 24, and through an adjacent second hole 22 from the second side of the top to or toward the first side of the top.

The tie down track 10 may be formed monolithically from a blank 10′ as shown in FIG. 2B. The blank defines a central section 12′ corresponding to the top 12, a first side tab 14′ corresponding to the first side wall 14, a second side tab 16″ corresponding to the second side wall 16, a first end tab 18′ corresponding to the first end wall 18, and a second end tab 20′ corresponding to the second end wall 20. The blank 10′ may be made of any suitable material, for example, steel or another durable and malleable metal.

The blank 10′ may be formed into the tie down track 10 by bending the first and second side tabs 14′, 16′ and the first and second end tabs 18′, 20′ with respect to the central portion 12′ to yield the general form of the tie down track 10. The bending may be performed, for example, using a brake or a punch and a suitable die. Adjacent ends of the first and second side tabs 14′, 16′ and the first and second end tabs 18′, 20′ may be connected together, for example, by welding after bending.

In an embodiment, the blank 10′ may be rectangular and formed into the general shape of the tie down track 10 using a punch and a suitable die or dies.

The holes 22 may be formed, for example, by punching or laser cutting the blank 10′. The holes 22 may be formed by physically removing from the blank 10′ the entirety (or any lesser amount) of the material defining the area of the central portion 12′ of the blank where the holes 22 are to be formed, as opposed to simply cutting such material and bending it out of the plane of the central portion of the blank. The holes 22 may be formed into the blank 10′ before or after the blank is bent or otherwise formed into the general shape of the tie down track 10.

The tie down track 10 may be attached directly to a vehicle chassis as discussed in the BACKGROUND section above. For example, at least a portion of any or all of the free ends of the side and end walls 14, 16, 18, 20 may be welded to a chassis member. The chassis member may be generally planar. In an embodiment, any two or more of the side and end walls 14, 16, 18, 20 may be placed in abutment with a top flange (typically, though not necessarily a planar member) of one or more frame rails and/or cross members and any or all of such side and end walls may be welded to the corresponding frame rails and/or cross members. In an embodiment, such frame rail(s) and/or cross member(s) may form a sixth side of the five-sided box defined by the tie down rack 10.

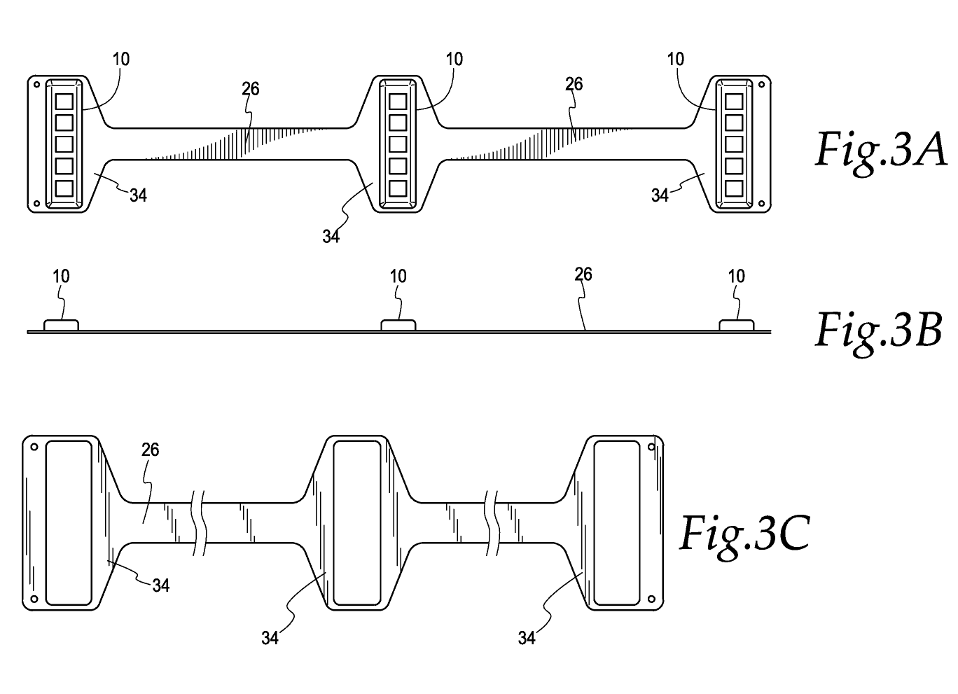

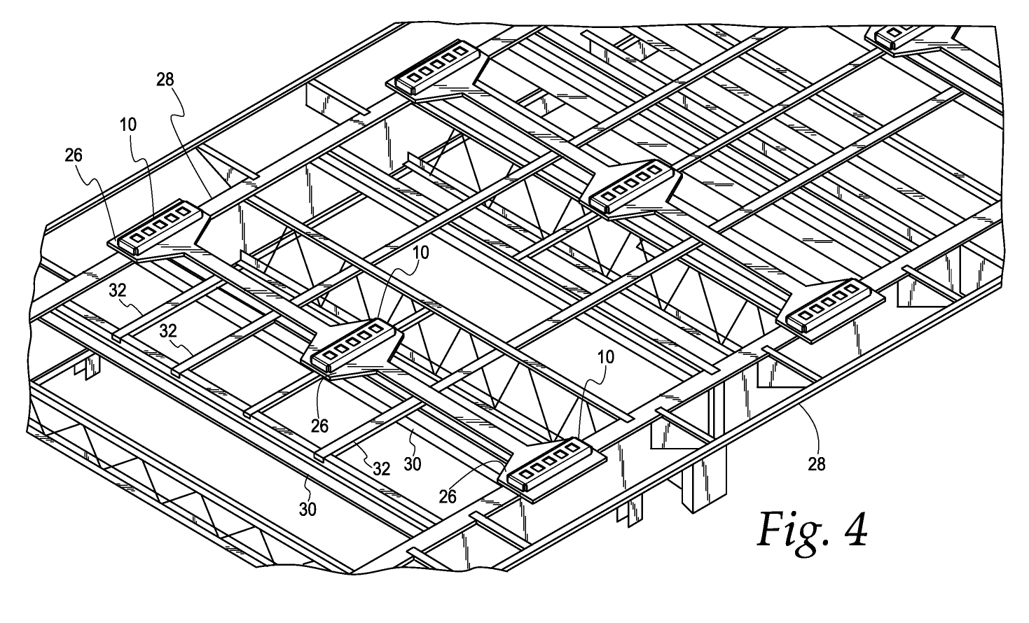

Alternatively, as best shown in FIGS. 3A, 3B, and 4, one or more tie down tracks 10 may be attached to a mounting plate 26 (which is shown in isolation in FIG. 3C). The mounting plate 26 may be embodied as a generally planar and linear strip of material defining one more mounting pads 34. Each of the mounting pads 34 may be substantially wider than portions of the mounting plate 26 connecting adjacent mounting pads or otherwise adjacent a mounting pad.

In an embodiment, at least a portion of any or all of the free ends of the side and end walls 14, 16, 18, 20 of the tie down track(s) 10 may be welded to the mounting plate 26. In embodiments wherein plural tie down tracks 10 are attached to the mounting plate 26, the plural tie down tracks may be configured so that the arrays of holes 22 therein are generally parallel to each other.

The mounting plate 26 may, in turn, be attached to the vehicle chassis. For example, as best shown in FIG. 4, the mounting plate 26 may be attached at or near its ends to a correspondingly-located frame rail 28 by welding, using mechanical fasteners or other suitable means. The mounting plate 26 may be attached at one or more intermediate portions along its length to a frame cross member 30 or an auxiliary longitudinal member 32 extending between cross members 30. In an embodiment, any or all portions of the mounting plate 26 proximate a tie down track 10 attached thereto may be attached to a corresponding frame rail 28, cross member 30, or auxiliary longitudinal member 32.

Both the tie down track 10 and the mounting plate may be made of steel or another suitable metal or other material.

A floor (not shown) may be disposed upon the frame rails 28, cross members 30, and auxiliary longitudinal members 32. Holes may be cut into the floor (not shown), the holes receiving the tie down tracks 10 therein. The upper surfaces of the tops 12 of the tie down tracks 10 may be substantially flush with the upper surface of the floor (not shown).

In use, an end of a tie down strap (not shown) may be hooked underneath a crossbar 24 of the tie down track 10, as suggested above, and the strap may be tightened in a known manner, for example, using a ratchet mechanism. Illustrative tie down strap ends include, without limitation, S-hooks and J-hooks. In an embodiment an end of such a hook may be inserted through a hole 22 of a tie down track 10 from a first side of the top 12 thereof, behind a crossbar 24 separating the crossbar from a second hole 22, for example, an adjacent hole 22, and through the second hole from the second side of the top of the tie down track to the first side thereof. The first side of the top 12 of the tie down track 10 may be a side opposite a mounting plate 26 or other structure to which the tie down track may be mounted, and the second side of the top of the tie down track may be a side adjacent such a mounting plate or other structure.

References to orientation or direction, for example, top, side, end, bottom, and the like, should be construed in the relative, and not absolute, sense unless context dictates otherwise.

The present disclosure describes and shows illustrative embodiments of a tie down track and system and methods of making and using the same. Features disclosed in a given embodiment may be employed in other embodiments to the greatest possible extent without departure from the scope of the invention set forth in the appended claims.

1. A method of making a tie down track comprising:
providing a blank;
forming the blank into a five-sided structure including a top having a first side and a second side, and first through fourth walls connected to the top, each of the first through fourth walls extending from the same side of the top; and
forming at least a first hole and a second hole through the top, the first hole and the second hole cooperating to define a cross bar between the first hole and the second hole.

2. The method of claim 1 wherein the step of forming the blank into the five-sided structure comprises punching or pressing the blank about a die.

3. The method of claim 1 wherein the blank comprises a central portion corresponding to the top and first through fourth tabs corresponding to the first through fourth walls extending from the central portion.

4. The method of claim 3 wherein the step of forming the blank comprises bending the first through fourth tabs about the central portion.

5. The method of claim 1 further comprising connecting at least one of the first through fourth walls to an adjacent one of the first through fourth walls at adjacent edges thereof.

6. The method of claim 1 wherein the step of forming the first hole comprises punching or laser cutting.

7. The method of claim 1 wherein the step of forming the first hole comprises physically removing from the blank the entirety of the material of the blank defining the area in which the holes are formed.

8. A monolithically-formed tie down track comprising:
a top having a first side and a second side, the top defining at least a first hole and a second hole therethrough, wherein the first hole and the second hole cooperate to define a crossbar therebetween; and
first through fourth walls connected to the top and extending from the same side of the top.

9. A system comprising the tie down track of claim 8 and a mounting surface, the tie down track connected to the mounting surface, and the system configured to selectively receive a hook through the first hole from the first side of the top to the second side of the top, from the first hole to the second hole between the top and the mounting surface, and through the second hole from the second side of the top to the first side of the top.

10. The system of claim 9 wherein free ends of two or more of the first through fourth walls abut the surface and are connected to the surface.

11. The system of claim 10 wherein the free ends of the two or more of the first through fourth walls are welded to the surface.

12. The system of claim 11 wherein the surface is a chassis member of a vehicle.

13. The system of claim 11 wherein the surface is a mounting plate configured for connection to a chassis member of a vehicle, the mounting plate comprising a mounting pad to which the tie down track is attached.

14. The system of claim 11 wherein the surface is a mounting plate configured for connection to a plurality of chassis members of a vehicle the mounting plate comprising a mounting pad to which the tie down track is attached.

15. The system of claim 14, the mounting plate comprising a second mounting pad, and the system comprising a second tie down track connected to the mounting plate.

16. The system of claim 15 wherein the plurality of holes defined by the first tie down track is arranged in a first array, wherein the plurality of holes defined by the second tie down track is arranged in a second array, and wherein the first array is parallel to the second array.

17. The system of claim 16 wherein the mounting plate is attached to a vehicle chassis.

18. The system of 16 wherein the mounting plate is attached to a vehicle chassis proximate each of the first and second mounting pads.
